(19) United States
(12) Patent Application Publication
(10) Pub. No.: US 2010/0036609 A1
(43) Pub. Date: Feb. 11, 2010

(54) NAVIGATION SYSTEMS AND NAVIGATION METHODS THEREOF

(75) Inventor: Fang-Wei Kang, TAIPEI CITY (TW)

Correspondence Address: QUINTERO LAW OFFICE, PC, 615 Hampton Dr, Suite A202, Venice, CA, 90291, US

(73) Assignee: MITAC INTERNATIONAL CORP., TAOYUAN (TW)

(21) Appl. No.: 12/501,363

(22) Filed: Jul. 10, 2009

(30) Foreign Application Priority Data
Aug. 6, 2008 (TW) TW97129798

(51) Int. Cl. G01C 21/00

(52) U.S. Cl. 701/207; 701/200

(57) ABSTRACT

Navigation methods for navigating an electronic device are disclosed. The method comprises the following steps. First, geographic data of a specific region having a plurality of installations is acquired. A signal comprising information corresponding to the current loading statuses for each of the installations of the specific region is received by the electronic device. Accordingly, information corresponding to the current loading statuses for each of the installation of the specific region is acquired from the received signal. The electronic device displays current loading statuses for each of the installations of the specific region on the geographic data so as to aid a user to plan a visiting route of the specific region and perform navigation in the specific region.

### CROSS REFERENCE TO RELATED APPLICATIONS

This Application claims priority of Taiwan Patent Application No. 097129798, filed on Aug. 6, 2008, the entirety of which is incorporated by reference herein.

### BACKGROUND OF THE INVENTION

1. Field of the Invention

The disclosure relates generally to navigation systems and related route planning methods, and, more particularly to navigation systems and related navigation methods that provide navigation and route planning within a specific region such as a theme park.

2. Description of the Related Art

Global Positioning System (GPS) technology has been widely used in navigation systems of various electronic devices, such as portable devices and electronic devices in cars to receive signals from GPS satellites. Accordingly, the position of an electronic device with a GPS receiver therein, can be determined according to responsive positioning signals between the electronic device and the satellites. Users may also use navigation software in the electronic device for route planning and navigation.

As user requirements changes, navigation systems not only provide navigation on traveled roads, but also provide geographic data of specific regions such as geographic data of a zoo or a theme park. Currently, a user may obtain his current position within the specific region by referring to the current position calculated by a navigation system and the geographic data of the specific region. However, while navigation systems provide positioning functions and display introductions for geographic data of a specific region, navigation systems do not provide detailed navigation information or functions within the specific region. Therefore, users may spend a large amount of time to seek target installations within a specific region or wait for the availability of an installation within the specific region.

### BRIEF SUMMARY OF THE INVENTION

Navigation systems and related navigation methods for a specific region are provided so as to provide further navigation support within a specific region.

An embodiment of a navigation method for navigating an electronic device is disclosed.

First, geographic data of a specific region having a plurality of installations is acquired. A signal comprising information corresponding to the current loading statuses for each of the installations of the specific region is received by the electronic device. Accordingly, information corresponding to the current loading statuses for each of the installation of the specific region is acquired from the received signal. The electronic device displays current loading statuses for each of the installations of the specific region on the geographic data so as to aid a user to plan a visiting route of the specific region and perform navigation in the specific region.

An embodiment of a navigation system for use in an electronic device comprises a display unit, a processing unit and a wireless signal receiving unit. The processing unit acquires geographic data of a specific region having a plurality of installations, wherein the electronic device performs navigation in the specific region based on the geographic data. The wireless signal receiving unit receives a signal comprising information corresponding to the current loading statuses for each of the installations of the specific region. The processing unit acquires the information corresponding to the current loading statuses for each of the installations of the specific region from the received signal and the electronic device displays current loading statuses for each of the installations of the specific region on the geographic data so as to aid a user to plan a visiting route of the specific region and perform navigation in the specific region.

Navigation methods and navigation systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a navigation system of the invention;

FIG. 2A is a schematic diagrams illustrating an embodiment of a specific region of the invention;

FIG. 2B is a schematic diagrams illustrating an embodiment of an installation within the specific region of the invention;

FIG. 3 is a flowchart of an embodiment of a navigation method of the invention;

FIG. 4 is a schematic diagrams illustrating an embodiment a navigation picture for a specific region of the invention; and

FIG. 5 is a flowchart of another embodiment of an updating method for updating current loading status for each installation of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

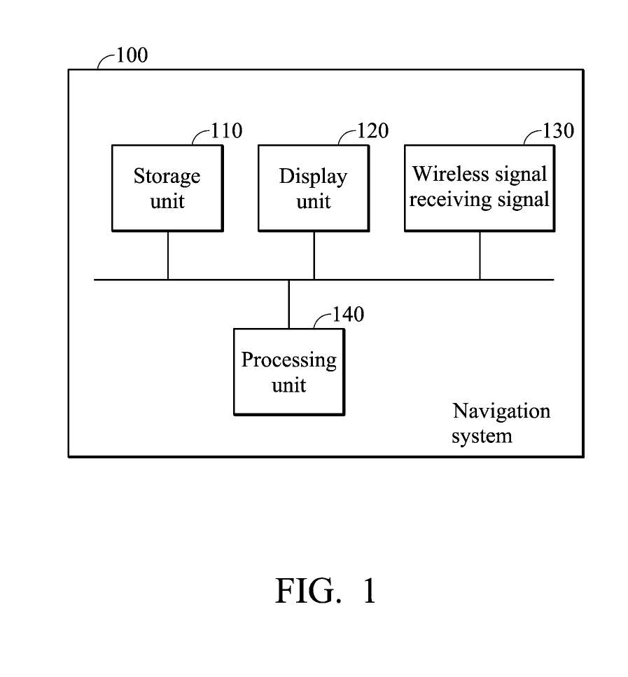

The invention is described with reference to FIGS. 1 through 5, which generally relate to navigation systems and related navigation methods that provide navigation and route planning within a specific region. In the following detailed description, reference is made to the accompanying drawings which from a part hereof, shown by way of illustration of specific embodiments. These embodiments are described in sufficient detail to enable those skilled in the art to practice the invention, and it is to be understood that other embodiments may be utilized and that structural, logical and electrical changes may be made, without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

Embodiments of the invention provide a navigation system and related navigation method for use in an electronic device to provide navigation information and display current loading status for each of the devices or installations within a specific region (such as a theme park) so as to aid users to plan a suitable visiting route according to requirements.

FIG. 1 is a schematic diagram illustrating an embodiment of a navigation system of the invention. The navigation system is suitable for use in an electronic device, such as a computer system or a portable device having a navigation function.

The navigation system 100 comprises a storage unit 110, a display unit 120, a wireless signal receiving unit 130 and a processing unit 140. The storage unit 110 comprises map data or geographic data corresponding to at least one specific region, such as an area, a theme park or a country. The map/geographic data may comprise doorplate addresses, landmarks, scenic spots, and/or road and information thereof. For example, in one embodiment, if the specific region is a theme park, the map/geographic data may be a travel map for the theme park in which positions of all of the installations within the theme park may be illustrated thereon. The display unit 120 displays related data, such as a user interface, route planning results, and related navigation information. The wireless signal receiving unit 130 may be any wireless communication module such as a blue-tooth communication module or wireless local area network (WLAN) communication module that meets IEEE 802.1X standards.

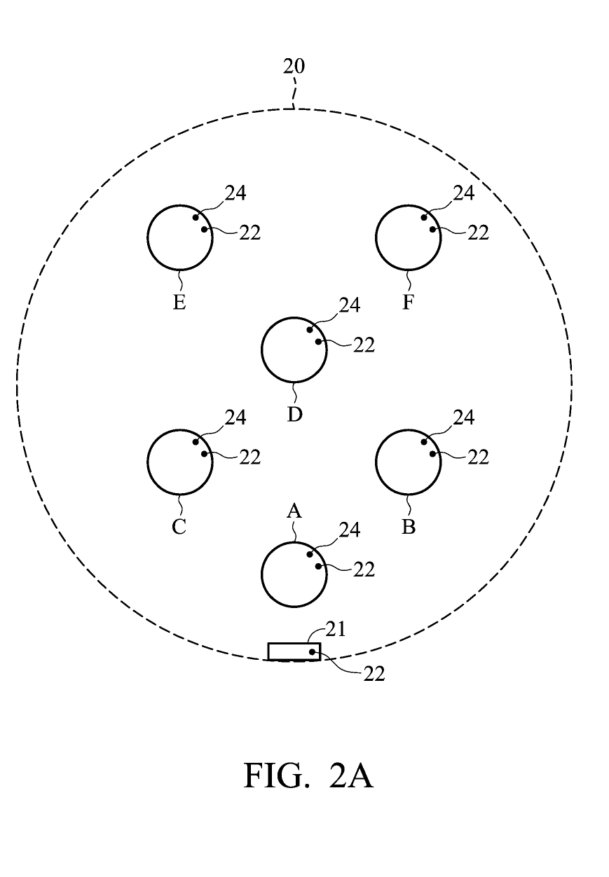

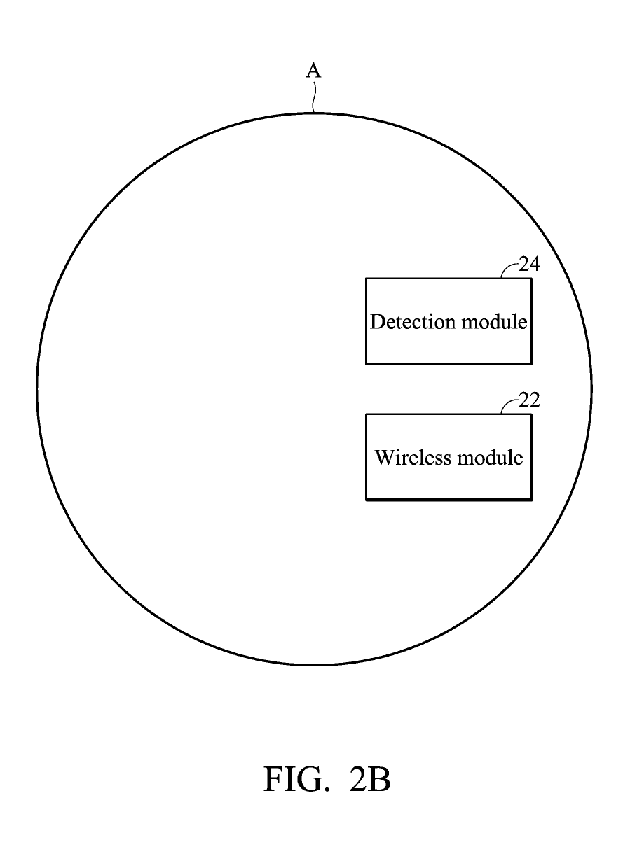

For example, please refer to FIG. 2A. FIG. 2A is a schematic diagram illustrating an embodiment of geographic data of a specific region of the invention. FIG. 2B is a schematic diagram illustrating an embodiment of an installation within the specific region of the invention. As shown in FIG. 2A, the specific region 20 comprises an entrance 21 and installations A-F wherein corresponding positions within the specific region of each installation are plotted. Each of the installations A-F has a corresponding wireless module 22 and a corresponding detection module 24, wherein a corresponding wireless module (not shown) is also configured at the entrance 21. The wireless module 22 is capable of performing wireless communication with the wireless signal receiving unit 130 of the electronic device. For example, if the wireless signal receiving unit 130 is a blue-tooth communication module, the wireless module 22 is a blue-tooth communication module which is capable of performing a blue-tooth communications with the wireless signal receiving unit 130. Users may use the wireless signal receiving unit 130 of the electronic device and the wireless module 22 of each of the installations to acquire up-to-date loading statuses of the installations.

The detection unit 24 is used for detecting current loading status of a corresponding installation and storing the detection result into a storage unit therein (not shown). In one embodiment, if the installation is one of the installations of a theme park, the current loading status information of which may comprise information regarding to a number of people waiting (queued) to use the installation, a number of people that is currently using the installation and an estimated waiting time for the installation. For example, the detection module 24 may further comprise an infra-red sensor that is capable of detecting body temperatures of people via infra-red. Thus, body temperature is used to detect and calculate the number of people waiting (queued) for the installation. Furthermore, the number of people waiting (queued) may be set as a condition and the detection module 24 may send an update message to inform the electronic device to update information when the number of people waiting (queued) is less than a predetermined number (e.g. less than ten persons). The estimated waiting time for the installation is relative to the number of people currently waiting to use the installation, a number of people currently using the installation and a corresponding operation time of the installation.

For example, for one kind of installation (e.g. a Roller coaster), if the number of people currently waiting is set to be X and a corresponding operation time needed for the installation to complete one operating cycle is set to be T, the estimated waiting time is substantially equal to X/T. In other embodiments, for another kind of installation (e.g. a Ferris wheel), if the number of people currently waiting is set to be Y and a corresponding operation time needed for the installation to complete one operating cycle is set to be T′, the estimated waiting time is substantially equal to Y/T′. Since the corresponding operation time needed for one installation to complete one operation is fixed and can be known in advance, the estimated waiting time of that installation can also be calculated based on acquired data corresponding thereto. Similarly, the estimated waiting time may also be set by other conditions and the detection module 24 may send an update message to inform the electronic device to update information when the estimated waiting time is less than a predetermined time value (e.g. less than 30 minutes). Note that the predetermined time value can be dynamically adjusted according to actual requirements.

The processing unit 140 may be a navigation engine having a route planning capability. Users may input navigation parameters, such as a starting point, a destination, and/or at least one mid-point via the user interface. The processing unit 140 performs route planning according to navigation parameters such as the starting point, the mid-point and the destination to obtain at least one route planning result. Users may be navigated to the destination according to a planned route which is obtained by the route planning result. It is noted that, the navigation system 100 may further comprise a signal receiving unit (not shown) to receive satellite signals. The processing unit 140 may then calculate current position of the electronic device based on the received signals. When the current position of the electronic device conforms to the route planning result, the processing unit 140 may proceed to provide a navigation function to move the electronic device to the destination according to the original route planning result. When the electronic device moves into a specific region, the processing unit 140 may perform navigation within the specific region according to a navigation method of the invention. The navigation method of the invention is detailed below.

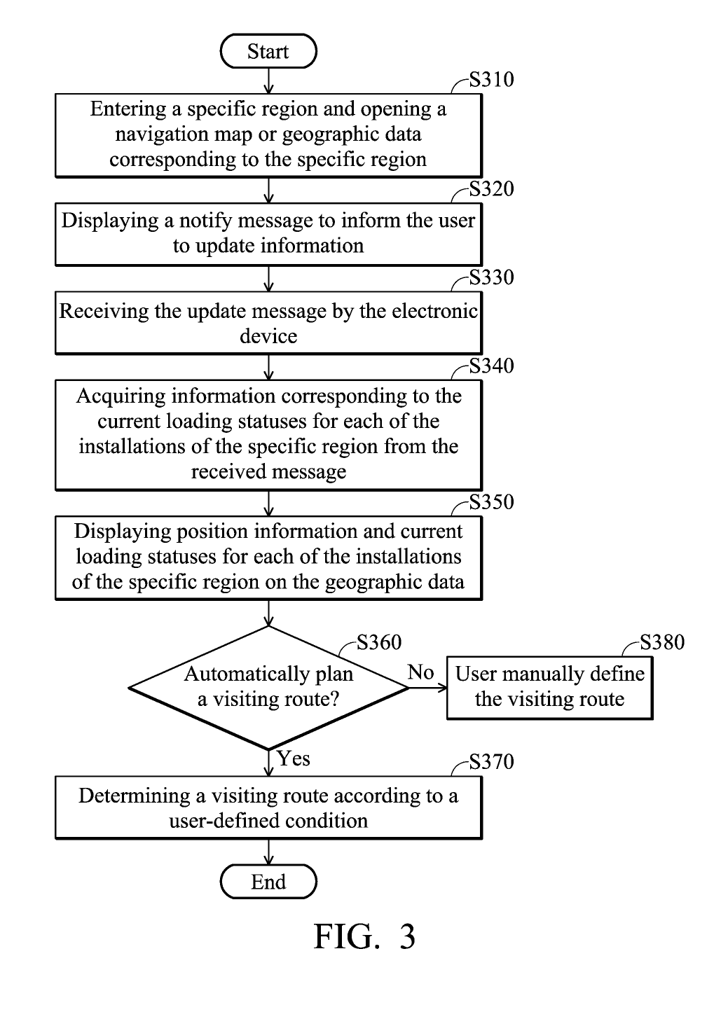

FIG. 3 is a flowchart of an embodiment of a navigation method of the invention. The navigation method is suitable for use in an electronic device, such as a computer system or a portable device having a navigation function.

In step S310, a specific region is entered and a navigation map or geographic data corresponding to the specific region is opened accordingly in which the specific region has multiple installations and multiple default points of interest (POIs), wherein relative position and coordinate of each installation or each POI within the specific region will be plotted on a map. It is to be noted that, in one embodiment, users may acquire the geographic data of the specific region by downloading the geographic data from a website and when the geographic data of the specific region has been modified, the geographic data of the specific region within the website may be accordingly modified. Therefore, the electronic device is capable of acquiring updated geographic data for navigation.

Accordingly, in step S320, the entrance of the specific region is passed through and a notify message is displayed to inform the user to update information. In reference to FIG. 2A, when the user utilizes the electronic device and enters into the specific region and passes through the entrance 21, a wireless communication is performed between the wireless signal receiving unit of the electronic device and the wireless module configured at the entrance 21 in which the wireless module will provide an update message that comprises information corresponding to the current loading statuses for each of the installations to the electronic device.

Therefore, in step S330, the electronic device receives (or downloads) the update message and, in step S340, the processing unit acquires the information corresponding to the current loading statuses for each of the installations of the specific region from the received message or signal. After the information corresponding to the current loading statuses for each of the installations of the specific region has been acquired, in step S350, the electronic device displays position information and current loading statuses for each of the installations of the specific region on the geographic data via a display unit.

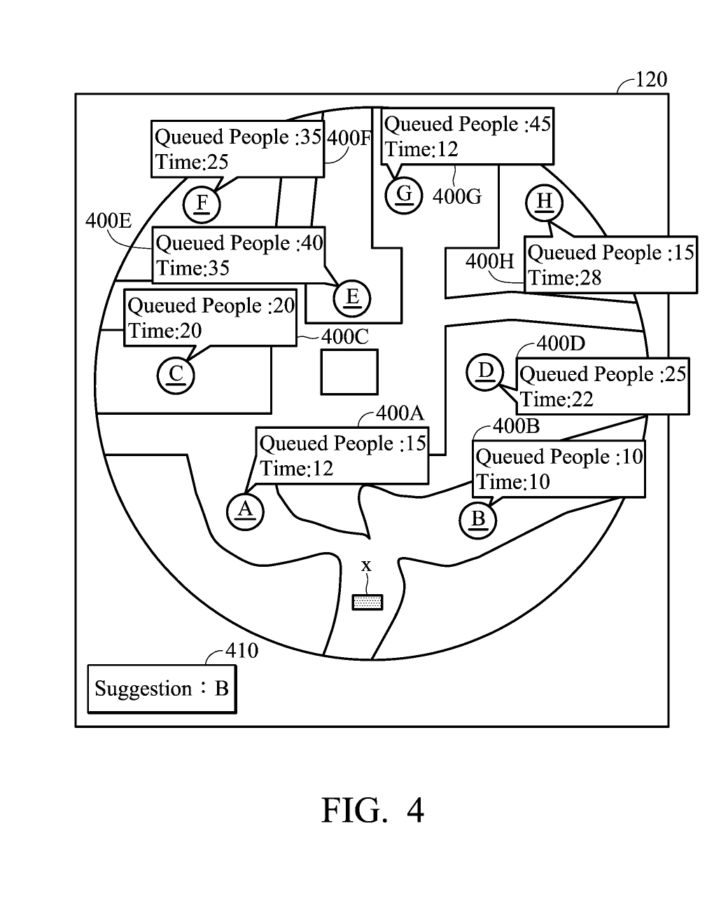

FIG. 4 is a schematic diagram illustrating an embodiment a navigation picture for a specific region of the invention. As shown in FIG. 4, the display unit 120 displays geographic data (navigation map) of a specific region and each of the installations A-H has corresponding current loading statuses 400A-400H, wherein X represents the current position of the electronic device. For example, the information of the current loading status for the installation A represents that the number of people currently waiting to use the installation A is 15 persons and the estimated waiting time for the installation A is 12 minutes while the information of the current loading status for the installation B represents that the number of people currently waiting to use the installation B is 10 persons and the estimated waiting time for the installation B is 10 minutes. In other words, for the electronic device located at current position X, the planned route and time required to use the installation B is less then the planned route and time required to use the installation A. Therefore, the installation B is set to be the best choice for the next installation to visit.

In step S360, it is determined whether to provide automatic route planning to plan a visiting route. If the user requests to plan the visiting route manually (No in step S360), the electronic device may provide a user interface for the user to define a user-defined visiting route (step S380). If the user does not request to plan the visiting route manually and would like a visiting route automatically provided (Yes in step S360), the electronic device may determine and generate the visiting route according to a user-defined condition (step S370). The user may configure the user-defined condition as, for example, a shortest path and/or the minimum waiting time rule, but it is not limited thereto. When the user-defined condition is configured as the shortest path rule, the processing unit 140 may plan a visiting route that satisfies the shortest path rule according to distances from the current position to each of the installations other than visited installations and provide a next suggested installation to visit based on the planned visiting route. When the user-defined condition is configured as the minimum waiting time rule, the processing unit 140 may plan a visiting route that satisfies the minimum waiting time rule according to distances from the current position to each of the installations other than visited installations and current loading statuses of each of the installations and provide a next suggested installation to visit based on the planned visiting route. For example, in reference to FIG. 4, if it is assumed that the distances from the current position to the installation A and the installation are the same and the user-defined condition is configured as the minimum waiting time rule, the processing unit 140 may obtain a next suggested installation to visit as installation B (as shown in 410) based on the minimum waiting time requirement.

For illustration, steps of the navigation method of the invention are detailed in the following embodiment.

In this embodiment, for brevity, it is assumed that the specific region is a theme park and the installations are installations of the theme park such as a Roller Coaster, a Ferris wheel and so on, but the invention is not limited thereto. Thus, the current loading status information of one installation may comprise information regarding to a number of people waiting (queued) to use the installation, a number of people currently using the installation and/or an estimated waiting time for the installation. In this embodiment, it is assumed that A represents the entrance of the theme park and the installations B and C represent the Roller Coaster and the Ferris wheel, respectively. Also, it is assumed that the installations B and C start operation at the same time and each operation cycle of the installation B is about 5 minutes, with operation capacity of 10 persons, and each operation cycle of the installation C is about 8 seconds, with operation capacity of 5 persons. Thus, if the distance from the point A to the installation B is the same as that from the point A to the installation C and the numbers people waiting (queued) to use the installations B and C are both set to be 20 persons, then the installation B may require about 10 minutes to service 20 persons while the installation C may require only about 32 seconds to service 20 persons. Thus, the next suggested installation to visit is obtained as the installation C based on the waiting time condition.

In another embodiment, If the number of people waiting (queued) to use the installations B and C are the same but the distance from the point A to the installation B is not the same as that from the point A to the installation C, then, the next suggested installation to visit may be obtained based upon both the distances and the waiting time conditions.

Therefore, a user may choose to automatically or manually plan a visiting route within a specific region by the provided current loading statuses for all installations such that visiting of installations that require longer waiting times and longer distances from a user's current position can be avoided, thereby significantly reducing time for seeking and waiting for installations in the specific region. In other embodiments, in addition to providing current loading status information of the installations (e.g. the number people waiting (queued) to use the installation and an estimated waiting time for the installation), other information regarding the installations may also be provided. For example, if the installation represents a theater that plays a show at predetermined show time, information regarding to the show time for the show may also be provided to the user and the user may be notified when the time of the show is near, so that the user may prepare to see the show if desired.

Furthermore, because current loading status information for an installation will vary at every predetermined time period, the provided current loading status information may be updated automatically and the electronic device may be informed when a predetermined condition is satisfied.

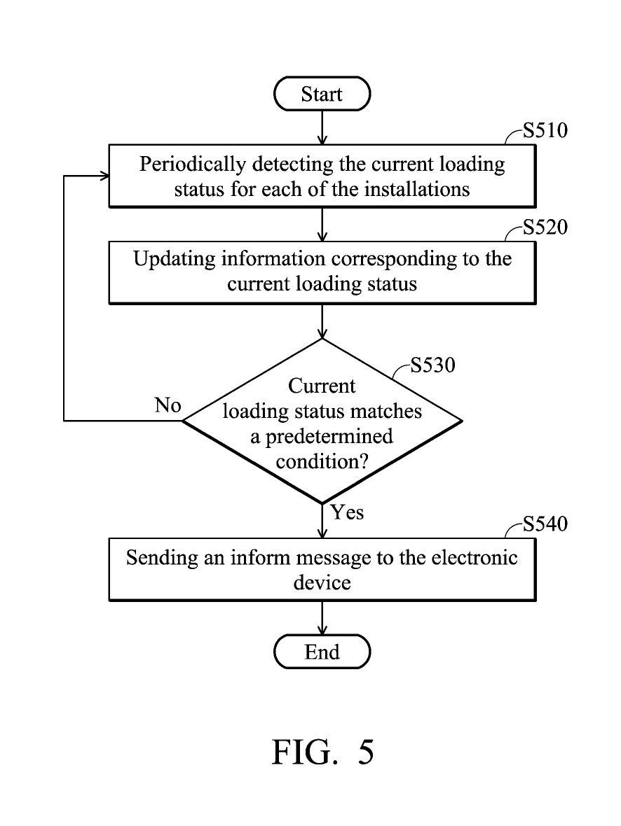

FIG. 5 is a flowchart of another embodiment of an updating method for updating current loading status for each installation of the invention. Updating methods for updating current loading statuses for each installation of the invention are installations within a specific region.

In step S510, the current loading statuses for each of the installations is periodically detected. For example, the detection module of each installation may be configured to be activated at every predetermined time period (e.g. every 5 minutes), so that detected current loading statuses may be updated. When detecting a variation in current loading status of the installation, in step S520, information corresponding to the current loading status is updated, i.e. information regarding newly detected current loading statuses is stored into a storage unit of the installation. Thereafter, in step S530, it is determined whether a current loading status matches a predetermined condition. For example, it is determined whether the number of persons currently waiting to use an installation is less than a predetermined value (e.g. less than 10 persons) or the estimated waiting time for the installation is less than a predetermined time value (e.g. less than 30 minutes). When determining that the current loading status does not match a predetermined condition (No in step S530), steps S510-S530 will be repeated to periodically detect and update the information corresponding to the current loading statuses for each of the installations. When determining that the current loading status matches a predetermined condition (Yes in step S530), in step S540, the installation may send an inform message (e.g. a traffic message channel (TMC) message) to the electronic device via a server. Note that the inform message may comprise information about installations meeting the predetermined conditions. After receiving the inform message, the electronic device may determine whether to add the installation indicated by the inform message or not and determine whether to request to automatically perform a route re-planning operation.

Therefore, the user is capable of being immediately updated of the latest current loading status information for each installation and able to control and plan a best suited visiting route through the wireless module of each installation.

In summary, according to the navigation system and related navigation method of the invention, when moving into a specific region such as a theme park, the electronic device can acquire current loading statuses for the known installations within the specific region at the entrance of the specific region and display the information on the navigation map such that the user may refer to the current loading statuses and a corresponding position information for each installation displayed on the navigation map, and manually choose a visiting route or have a visiting route automatically planned, thereby significantly reducing time for seeking and waiting for target installations within the specific region. Moreover, current statuses for all of the installations within the specific region can further be broadcasted to other electronic devices that also have a navigation system and is not within the specific region via a broadcasting message such as a traffic message channel (TMC) message) before they enter the specific region, which assists in marketing of the specific region.

Navigation systems and navigation methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A navigation method for navigating an electronic device, comprising:
acquiring geographic data of a specific region having a plurality of installations;
receiving a signal comprising information corresponding to the current loading statuses for each of the installations of the specific region by the electronic device; and
displaying current loading statuses for each of the installations of the specific region on the geographic data by the electronic device so as to aid a user to plan a visiting route of the specific region and perform navigation in the specific region,
wherein the user determines whether to visit an installation based on the current loading status thereof.

2. The navigation method of claim 1, further comprising:
providing each of the installations at least one detection module for acquiring the information corresponding to the current loading statuses for each of the installations.

3. The navigation method of claim 2, further comprising:
generating the signal according to the acquired information corresponding to the current loading statuses for each of the installations; and
transmitting the signal to the electronic device.

4. The navigation method of claim 2, further comprising:
periodically detecting and updating the information corresponding to the current loading statuses for each of the installations utilizing the detection module of each installation.

5. The navigation method of claim 4, further comprising:
transmitting a message for informing the electronic device when the detected current loading status of one of the installations matches a predetermined condition.

6. The navigation method of claim 2, wherein the information corresponding to the current loading status of one installation at least comprises a number of people that is currently waiting to use the installation and an estimated waiting time for the installation.

7. The navigation method of claim 6, wherein the estimated waiting time for the installation is relative to the number of people currently waiting to use the installation, a number of people currently using the installation and a corresponding operation time of the installation.

8. The navigation method of claim 7, further comprising:
transmitting a message for informing the electronic device when the estimated waiting time for the installation is less than a predetermined time value.

9. The navigation method of claim 1, further comprising:
acquiring a current position of the electronic device; and
determining the visiting route, by the electronic device, according to the information comprising current loading status and the position for each of the installations and the acquired current position.

10. The navigation method of claim 9, further comprising:
determining the visiting route, by the electronic device, according to a user-defined condition and the information comprising current loading statuses for each of the installations.

11. The navigation method of claim 1, wherein the specific message is a broadcasting message.

12. The navigation method of claim 1, wherein the specific region is a theme park and the installations are installations of the theme park.

13. A navigation system for use in an electronic device, comprising:
a display unit;
a processing unit, acquiring geographic data of a specific region having a plurality of installations, wherein the electronic device performs navigation in the specific region based on the geographic data; and
a wireless signal receiving unit, receiving a signal comprising information corresponding to the current loading statuses for each of the installations of the specific region,
wherein the processing unit acquires the information corresponding to the current loading statuses for each of the installations of the specific region from the received signal and the electronic device displays current loading statuses for each of the installations of the specific region on the geographic data so as to aid a user to plan a visiting route of the specific region and perform navigation in the specific region.

14. The navigation system of claim 13, wherein each of the installations further comprises at least one detection module for acquiring the information corresponding to the current loading statuses for each of the installations.

15. The navigation system of claim 13, wherein each of the installations further comprises a wireless module and the processing unit further generates the signal according to the acquired information corresponding to the current loading statuses for each of the installations and transmits the signal to the electronic device through the wireless module.

16. The navigation system of claim 13, wherein the detection module for each installation further detects and updates the information corresponding to the current loading statuses for each of the installations periodically.

17. The navigation system of claim 16, wherein the detection module further transmits a message for informing the electronic device when the detected current loading status of one of the installations matches a predetermined condition.

18. The navigation system of claim 13, wherein the processing unit further acquires a current position of the electronic device and the electronic device further determines the visiting route according to the information comprising current loading status and the position for each of the installations and the acquired current position.

19. The navigation system of claim 18, wherein the information corresponding to the current loading status of one installation at least comprises a number of people that is currently waiting to use the installation and an estimated waiting time for the installation.

20. A machine-readable storage medium comprising a computer program, which, when executed, causes a device to perform a navigation method, and the method comprising:
acquiring geographic data of a specific region having a plurality of installations;
receiving a signal comprising information corresponding to the current loading statuses for each of the installations of the specific region by the electronic device; and
displaying current loading statuses for each of the installations of the specific region on the geographic data by the electronic device so as to aid a user to plan a visiting route of the specific region and perform navigation in the specific region,
wherein the user determines whether to visit an installation based on the current loading status thereof.
